(19) United States
(12) Patent Application Publication
(10) Pub. No.: US 2026/0175336 A1
(43) Pub. Date: Jun. 25, 2026

(54) Spindle System With an Induction Element Integrated Into the Clamping Section of the Tool Holder

(71) Applicant: DMG MORI Ultrasonic Lasertec GmbH, Stipshausen (DE)

(72) Inventors: Gaston SCHWENK, Simmern (DE); Viktor DOLINGER, Bernkastel-Kues (DE); Phillip GÖBEL, Bad Sobernheim (DE); Fabian FRANZMANN, Veitsrodt (DE); Jens KETELAER, Wiesbaden (DE)

(21) Appl. No.: 19/422,569

(22) Filed: Dec. 17, 2025

(30) Foreign Application Priority Data
Dec. 20, 2024 (DE) 10 2024 139 422.6

(51) Int. Cl. B23Q 1/70

(52) U.S. Cl. CPC B23Q 1/70

(57) ABSTRACT

A spindle system 100 comprises a spindle device 500 with a housing 102 and a work spindle to which a tool holder 400 can be releasably connected and a tool holder 400, with a clamping section 401, a gripper section 403, a tool receiving section 404 and a vibration transducer 405 coupled thereto and an energy transmission device 103 comprising a first induction element 104a and a second induction element 104b which are radially opposed to each other when the tool holder 400 is connected to the work spindle, wherein the second induction element 104b is formed integrally with the clamping section of the tool holder 401 such that an automated changing device can engage in the gripper section of the tool holder 403.

### TECHNICAL FIELD

The present invention relates to a spindle system, in particular for ultrasonic machining of workpieces, with a tool which is connected to a rotationally driven work spindle by means of an exchangeable tool holder, wherein energy is transmitted to the tool holder in a contactless manner.

### BACKGROUND OF THE INVENTION

Spindle systems which are configured for ultrasonic machining of a workpiece with a rotating tool are already known from the prior art. Such systems are usually equipped with a vibration transducer which is connected to a tool receptacle of the tool holder in order to transmit vibrations to a tool received in the tool holder.

For this purpose, use is made, for example, of vibration transducers which are based on piezo elements which are used as an actuator for generating vibrations. These piezo elements are regularly produced from piezo-ceramics and are usually used as a stack. In order to generate a vibration, an electrical voltage is applied to such a stack. As a result, the stack of piezo elements deforms on account of the inverse piezoelectric effect.

Since specific geometrical relationships between the position of the vibration transducer and the position of the tool holder have to be taken into consideration for an effective transmission of vibrations to the tool, the vibration transducer is often installed directly in the tool holder.

In this configuration, the problem arises of producing an electrical connection between the rotating spindle with the connected tool holder and the vibration transducer installed therein and the surrounding static housing of the spindle, or the housing of the machine.

In this respect, for example, patent specification EP 3 616 830 A1 discloses a construction in which electrical energy is transmitted inductively from a coil in the spindle housing to a coil which is connected to the spindle shaft and consequently rotates together with the latter. The electrical energy of the rotating coil on the spindle shaft is transmitted to the vibration transducer in the tool holder by spring-loaded pins of a tool holder which make contact with a corresponding connecting surface when the tool holder is connected to the spindle.

However, this procedure has some disadvantages. In order to be able to ensure electrical conductivity, the spring-loaded pins on the tool holder and the contact surfaces on the spindle shaft always have to be kept clean. However, the contact surfaces and the spring-loaded pins are located directly in the connecting region of the tool holder to the spindle shaft and thereby come into direct contact with lubricants, for example. Furthermore, this connecting region is also in the direct vicinity of the machining region which is contaminated to a particularly great extent, inter alia, by the use of coolant. Consequently, the position of the electrical connection can only be kept clean with considerable additional effort. In the worst case, contamination is even detected only during workpiece machining by virtue of the fact that surface machining does not take place as planned.

Further alternative known from the prior art attempts to solve these problems by virtue of the fact that the coil is attached directly to the tool holder. The coil is usually seated above the region in which the tool is received in the tool holder. In this case too, the electrical connection is established by means of a second coil which is coupled inductively to the coil of the tool holder. In order to make it possible to change the tool holder over the receiving region of the tool despite the position of the coil on the tool holder, the geometry of the static coil is limited in such a configuration. In this case, in particular, it is not possible to use a coil which lies radially opposite the rotating coil of the tool holder over the entire circumference.

Instead, use is made of a static coil which is positioned radially opposite the rotating coil of the tool holder merely over part of the circumference, for example over half or a third. In this way, irrespective of the position of the rotating coil on the tool holder above the tool receiving region, it is possible to separate the tool holder from the spindle in an automated manner. However, the limitation of the extent of the static coil to a partial region of the circumference leads to a significantly reduced transmission efficiency of the electrical energy to the rotating coil of the tool holder.

In summary, the solutions known from the prior art for transmitting electrical energy from a static machine side to a rotating tool holder therefore have problems with respect to maintenance efficiency, reliability of connection and connection efficiency.

### SUMMARY

It is an object of the present invention to provide a spindle system which avoids the abovementioned problems.

It is a further object of the present invention to provide a tool holder with a clamping which can be subjected to extremely high mechanical loading, wherein the tool holder at the same time permits a more efficient and more reliable contactless transmission of electrical energy from a static environment of a spindle, to which the tool holder is connected, to the rotating tool holder than the solutions known hitherto from the prior art.

It is a further object of the present invention to provide a machine tool, in particular for machining a workpiece using oscillations in the ultrasonic range, wherein the electrical energy required for generating the ultrasonic oscillations is transmitted from a static part of the machine to the rotating tool holder in a contactless, more efficient and more reliable manner than in solutions as are known from the prior art. Furthermore, the tool holder connected to the work spindle of the machine tool is to be able to be exchanged by means of an automated changing device.

To achieve these objects, a spindle system according to claim 1, a tool holder according to claim 4, a spindle device according to claim 9, and a machine tool according to claim 10 are provided.

The respective dependent claims relate to preferred embodiments which can each be provided by themselves or in combination.

According to a first aspect of the invention, a spindle system for use on a machine tool is provided, comprising at least a spindle device, a tool holder and an energy transmission device.

The spindle device in turn comprises a rotationally driven work spindle with a receiving section for releasably connecting a tool holder and a spindle housing in which the work spindle is mounted.

Releasable connections are to be understood as meaning connections which can be released again in a non-destructive manner. In particular, screwing, clamping, clamping or connecting by means of a safety connection, such as a bayonet closure, are to be understood as releasable connections.

Furthermore, the tool holder in turn comprises at least a clamping section for releasably connecting to a work spindle of a spindle device, a gripper section which is arranged below the clamping section relative to a clamping end of the tool holder, a tool receiving section and a vibration transducer coupled to this tool receiving section and configured to vibrate a machining tool received in the tool receiving section.

The clamping end of the tool holder is to be understood as meaning the axial end of the tool holder at which the tool holder is connected to a work spindle, while the opposite axial end is referred to as the tool-side end. In particular, the clamping section is located at the clamping end of the tool holder and the tool holder is configured to be connected to a work spindle only by means of this clamping section, with the result that the clamping end denotes a clear axial side of the tool holder. An arrangement below the clamping section relative to the clamping end is consequently to be understood as meaning that firstly the clamping section and subsequently the gripper section are arranged on the tool holder in the axial direction from the clamping end to the tool-side end. If the tool holder is therefore connected to a work spindle, the gripper section is located with the tool-side end oriented downward, i.e. below the clamping section, in the case of a vertical orientation of the tool holder.

Furthermore, the energy transmission device comprises a first induction element and a second induction element. The energy transmission device is also configured to transmit energy between the first induction element and the second induction element radially opposite the first induction element in a contactless manner when the tool holder is connected to the work spindle for supplying energy to the vibration transducer. In particular, these elements can in each case be coils which are configured to be coupled inductively in order thus to enable contactless transmission of electrical energy. Particularly advantageously, the two induction elements are arranged in such a way that they lie radially opposite one another when the tool holder is connected to the work spindle.

The first induction element is in this case arranged on the spindle housing. This induction element can in this case advantageously be configured as a static induction element, that is to say it is located in a fixed position relative to the rotationally driven work spindle. Advantageously, this first induction element is arranged in an annular manner on the spindle housing in such a way that the axis of the work spindle runs centrally through the induction element. Particularly advantageously, the first induction element is integrated in the spindle housing and arranged in such a way that an outer contour of the induction element lies completely within an outer contour of the spindle housing. The second induction element is arranged on the tool holder in the clamping section. Advantageously, the second induction element is arranged in an annular manner on the clamping section of the tool holder in such a way that a central axis of the tool holder runs centrally through the induction element. In particular, when the tool holder is connected to a work spindle, the axis of the work spindle runs centrally through the second induction element.

Particularly advantageously, therefore, the first and the second induction element are arranged in an annular manner in such a way that, when the tool holder is connected to a work spindle, an axis of rotation of the rotationally driven work spindle runs centrally through both induction elements.

Furthermore, the induction elements are additionally oriented in such a way that they lie radially opposite one another when the tool holder is connected to a work spindle. That is to say, in particular, that the first induction element and the second induction element are arranged in such a way that they extend perpendicularly to an axis of rotation of the rotationally driven work spindle. In this case, it is particularly advantageous if the first and the second induction element are oriented concentrically. In the case of this orientation, both induction elements arranged in an annular manner are in each case at the same distance from one another over the entire circumference, which guarantees a high transmission efficiency.

An inductive coupling of induction elements lying radially opposite one another when the tool holder is connected to a work spindle has an improved transmission reliability in relation to induction elements oriented axially with respect to one another if incorrect orientations of the tool holder connected to a work spindle occur. In particular, incorrect orientations in which the tool holder is not clamped correctly and is consequently connected too deeply to the work spindle are to be considered here. The tool holder is therefore connected incorrectly to the work spindle, for example, in such a way that the receiving section of the work spindle does not engage completely in the clamping section of the tool holder. When viewed with the tool holder oriented downward along the axis of rotation of the work spindle, the tool holder is consequently seated too deeply on the work spindle.

In the case of an axial orientation of the induction elements, such a misorientation leads to the distance between induction elements increasing, which has a greatly negative influence on the transmission efficiency.

If, by contrast, the induction elements are oriented radially with respect to one another, the distance between the induction elements is predetermined substantially by the arrangement of the induction elements on the tool holder and on the spindle housing. In this case, a misorientation of the tool holder along the axis of rotation leads mainly to the induction element of the tool holder being seated somewhat too deeply, which, however, has far less effects for the transmission efficiency than a change in the distance between the induction elements.

According to the first aspect of the invention, the second induction element is formed integrally with the clamping section of the tool holder such that an automated changing device can engage in the gripper section of the tool holder.

This integral formation with the clamping section of the tool holder is advantageous over solutions known from the prior art for a plurality of reasons.

Firstly, existing automation devices can continue to be used since they can engage in the gripper section of the tool holder as usual. The gripper section is thus not impaired by the tool holder comprising further functionality, namely an induction element for supplying energy to a vibration transducer. The suitability of the tool holder for ultrasonic machining by means of the comprised induction element and the comprised vibration transducer is, so to speak, transparent for automation devices which are based on an engagement in the gripper section of the tool holder. As a result, the flexibility of use and, as a direct consequence, the economic viability of the corresponding devices is increased since the automation device can be provided independently of any ultrasonic machining.

Secondly, the integral formation of the second induction element with the clamping section of the tool holder permits particularly favorable positioning of the first induction element which transmits electrical energy to the second induction element in a contactless manner. The first induction element can be positioned in the spindle housing close to the region in which the tool holder is connected to the work spindle, but without extending into the machining region. Therefore, unfavorable interference contours in the machining region are avoided which, on the one hand, directly reduce the machining flexibility and, on the other hand, can also lead to problems with additional automation devices.

Particularly advantageously, the first induction element can also be configured as a coil which completely, that is to say at 360°, encompasses the region in which the tool holder is connected to the work spindle and in which the second induction element is arranged when the tool holder is connected to a work spindle. This increases in a particularly advantageous manner the transmission efficiency of electrical energy to the second induction element over solutions from the prior art which have arranged a first induction element merely on a partial section of the circumference of a second induction element.

In a particularly advantageous embodiment, the clamping section of the tool holder is formed as a hollow shaft taper. In particular, the clamping section can be formed as a standardized hollow shaft taper (HSK). Particularly advantageously, the second induction element is formed integrally with the standardized hollow shaft taper, in particular in such a way that the clamping section with integrally formed induction element meets all the regulatory requirements for the HSK.

This embodiment is particularly advantageous since the HSK is configured according to the standard with a planar contact surface which is arranged above the gripper section when the tool is oriented downward. In the case of a tool holder connected to a spindle axis, a proportion of the total clamping force in the case of a planar contact surface is more than 80%, whereby this is critically responsible for the limiting load and rigidity of the connection of the spindle axis to the tool holder. Since this planar contact surface is not perforated by contact pins or the like, or since the planar contact surface can be formed in accordance with the HSK standard on account of the integral formation of the induction element with the clamping section, a higher limiting load and rigidity of the connection of tool holder and spindle axis is possible. Therefore, in this embodiment, machining operations are possible which require greater forces than in the case of solutions in which, for example, contact pins or the like run through the planar contact surface.

In a further advantageous embodiment, the clamping section of the tool holder is formed as a steep taper. This embodiment permits a simple tool change, or change of the tool holder, which is advantageous particularly in the case of a high degree of automation of the workpiece machining when using many different tools. Furthermore, the steep taper permits a small distance between the cutting edge of a tool received in the tool holder and a spindle bearing of the work spindle to which the tool holder is connected, as a result of which a high flexural rigidity is achieved.

In a further particularly advantageous embodiment, the tool holder additionally comprises lines which are connected to the vibration transducer in a solder-free manner for the purpose of transmitting electrical energy from the induction element of the tool holder to the vibration transducer.

This embodiment is particularly advantageous if use is made of a vibration transducer which is based on a stack of piezo elements. For these piezo stacks, it is usual to solder the electrodes for exciting the piezo elements with a solderable material. On account of the mostly very compact embodiments of piezo stacks, these contact-connections are made directly on the piezo stack, with the result that, in some cases, very pronounced solder points are present on the longitudinal sides of a piezo stack. These pronounced solder points reduce, on the one hand, the miniaturization potential since corresponding space has to be provided in the tool holder and, on the other hand, the soldering is a manual process, which considerably reduces the production efficiency.

The solder-free connection therefore reduces, inter alia, the space requirement of the vibration transducer, which also reduces the minimum required size of the tool holder. In combination with the integral production of clamping section and second induction element, this leads to a tool holder which is configured for ultrasonic machining without necessarily resulting in changed dimensions of the tool holder. Therefore, no additional adaptations to possible automation devices, such as tool changers or magazines, have to be made.

Furthermore, the production efficiency of the tool holders of this advantageous embodiment is also considerably increased since the production step of manual soldering is dispensed with.

According to a second aspect of the invention, a tool holder for a spindle system is provided, wherein the tool holder comprises a clamping section for releasably connecting to a work spindle of a spindle device, a gripper section arranged below the clamping section relative to a clamping end of the tool holder, a tool receiving section and a vibration transducer coupled to the tool receiving section and configured to vibrate a machining tool received in the tool receiving section. The tool holder has arranged in the clamping section an induction element which, when the tool holder is connected to a work spindle, is configured to receive electrical energy in a contactless manner and to pass it on to the vibration transducer. This induction element is formed integrally with the clamping section of the tool holder such that an automated changing device can engage in the gripper section of the tool holder.

Since the induction element is produced integrally with the tool holder, the latter can be used as required for ultrasonic machining of a workpiece. The induction element formed integrally with the clamping section can then receive electrical energy from another induction element in a contactless manner and pass it on to the vibration transducer which is coupled to the tool receiving section. As a result, the vibration transducer can vibrate the tool receiving section and, as a direct consequence, a tool received in the latter.

If, on the other hand, no ultrasonic machining is required, or if a machine, for example in the absence of an induction element for transmitting electrical energy, does not support any ultrasonic machining, the tool holder can nevertheless be used since the induction element is formed integrally with the clamping section of the tool holder and therefore, for example, interference contours in the machining region are avoided. Such interference contours can result if induction elements are attached to the outer side of the tool holder. As a result, the flexibility of use and therefore also the economy of the tool holder is increased in relation to tool holders which are fixed to one of the two machining methods.

In a particularly advantageous embodiment of the tool holder, the clamping section thereof is formed as a hollow shaft taper. The advantages thereof have already been explained above.

In a further advantageous embodiment of the tool holder, the latter is formed as a steep taper. Advantages in this respect have also already been explained.

Particularly advantageously, the tool holder additionally comprises lines which are connected to the vibration transducer in a solder-free manner for the purpose of transmitting electrical energy from the induction element to the vibration transducer. Advantages of the solder-free connection of the induction element to the vibration transducer have likewise already been explained.

Furthermore, it is particularly advantageous if a connecting section of the tool holder, which connecting section comprises at least the clamping section and the gripper section, is produced at least in two parts. As a result of the two-part production, the induction element can be produced particularly advantageously integrally with the clamping section. Thus, for example, two different elements can be preproduced, one of which substantially forms the clamping section, wherein a cutout is provided into which the induction element can be fitted. A second section, which substantially comprises the gripper section and a connecting section to the rest of the tool holder, can be formed such that it joins together in a precisely fitting manner with the first part which forms the clamping section, in order to enclose the induction element in the cutout of the clamping section. These two parts joined together in a precisely fitting manner thus form the connecting section of the tool holder and enclose the induction element. The preproduction of the individual parts of the connecting section of the tool holder thus permits simple assembly and integration of the induction element. In particular, the two individual parts can be pressed, adhesively bonded, welded or connected to one another in a non-destructive, releasable or non-releasable manner in some other manner, wherein they always enclose the induction element of the tool holder.

Furthermore, leadthroughs such as, for example, bores can be provided in one or both of the individual parts which form the connecting section of the tool holder, which leadthroughs permit lines to be inserted in order to connect the induction element, for example, to the vibration transducer of the tool holder.

In an alternative advantageous embodiment, the tool holder has arranged in the clamping section a circumferential groove into which the induction element is at least partially embedded. This embodiment further reduces the production complexity by the tool holder being able to be produced in one piece. For this purpose, the tool holder is produced in a known manner before a groove is arranged in the clamping section. In particular, this groove can be milled or turned. The induction element of the tool holder can then be at least partially embedded in this groove. In particular, the induction element can be embodied as a coil which is wound directly into this groove in the clamping region of the tool holder. Alternatively, a ferrite element, for example a ferrite element which has a U-shaped cross section, can first be inserted into the groove before the coil is wound into the ferrite element arranged in the groove.

Advantageously, the induction element is thus provided in the clamping region of the tool holder, or the clamping region is formed in such a way that an outer diameter of the clamping region of the tool holder in the region in which the induction element is arranged is equal to an outer diameter of the clamping region of the tool holder in the region in which the induction element is not arranged.

If, for example, the connecting region of the tool holder is embodied in two parts, the part which forms the clamping region of the tool holder can be produced with a constant outer diameter. In particular, the outer diameter does not change in the region which has arranged the cutout in which the induction element is received. As a result, the induction element can be formed integrally with the clamping region of the tool holder without the outer diameter of the clamping region having a change.

If the outer diameter is additionally produced according to a corresponding standard, this results in a clamping region which conforms to the standard and differs merely in that the corresponding tool holder is additionally configured, on account of the integrated induction element, to permit ultrasonic machining of workpieces. This suitability for ultrasonic machining is, however, transparent for automation devices, such as automatic tool changers and/or tool magazines or the like, that is to say that special precautions do not have to be taken in order to change and/or store such a tool holder in an automated manner by means of such a device, nor does a machine which is to be used for the ultrasonic machining require separate automation systems if tool holders produced in such a way are used.

In the same way, a tool holder with a groove in the clamping section can advantageously also be free of a change in the outer diameter in the clamping region if the induction element of the tool holder is countersunk in the groove or is embedded or wound into the groove in such a way that it extends straight to the outer diameter of the clamping section. In particular, the induction element is formed in such a way that it completely fills the groove without extending beyond the latter.

Furthermore, the clamping section with an induction element formed integrally with the latter can advantageously be formed in such a way that a relative change in an outer diameter of the clamping region in the axial direction of the tool holder in the region in which the induction element is arranged is equal to a relative change in the outer diameter of the clamping region in the axial direction of the tool holder in the region in which the induction element is not arranged. In particular, the relative change in the outer diameter is in each case determined in the same axial direction of the tool holder.

For example, an outer diameter of the clamping section increases continuously from a clamping end of the tool holder to the gripper section of the tool holder. This can be the case if the clamping section is embodied as an HSK or as a steep taper. In this case, the outer diameter of the clamping section changes according to the respective cone definition or cone standard. In particular, the region in which the induction element is formed integrally with the clamping section does not differ from the surrounding regions of the clamping section with regard to a change in the outer diameter.

Particularly advantageously, the clamping section is formed integrally with the induction element in such a way that the clamping section meets all the requirements of a standard, for example an HSK standard or a steep taper standard, with regard to the dimensions and in particular with regard to changes in the outer diameter. Relevant standards in this respect are, inter alia, ISO 12164 (DIN 69893-1) and ISO 7388-1.

This advantageous embodiment increases the flexibility of use since a tool holder configured in such a way can be used in all machine tools which are equipped with an interface which conforms to the standard.

According to a further aspect of the invention, a spindle device for use in a spindle system is provided. The spindle device comprises at least one rotationally driven work spindle with a receiving section for a tool holder, a spindle housing in which the work spindle is mounted and an induction element which is arranged on the spindle housing, wherein the induction element is configured to transmit electrical energy to an induction element of the tool holder in a contactless manner when the tool holder is connected to the work spindle.

In this case, the induction element which is arranged on the spindle housing is advantageously arranged in such a way that it lies radially opposite an induction element which is produced integrally with the clamping section of a tool holder when this tool holder is connected to the comprised work spindle.

In a particularly advantageous embodiment, the induction element which is arranged on the spindle housing is configured in an annular manner and is oriented perpendicularly to the main direction of extent of the work spindle in such a way that the work spindle extends through a centre of the induction element which is configured in an annular manner. In particular, the induction element advantageously extends over 360° of a radial circumference of the work spindle. This advantageous embodiment considerably increases the transmission efficiency over induction modules which extend merely over a partial circumference (for example merely over 90° or 120°).

Particularly advantageously, the induction element which is arranged on the spindle housing is configured to be fastened in a displaceable manner perpendicularly to the main direction of extent of the work spindle. As a result, the flexibility of use is further increased since induction elements of tool holders can be coupled inductively in this way even if they are in each case arranged at different positions. This can be the consequence, for example, of differing dimensions of clamping regions of different tool holders. Thus, a tool holder could have a relatively long clamping section, as a result of which an induction element which is formed integrally with this clamping section could be seated more deeply in relation to the work spindle. In this case, the induction element could be displaced downward on the spindle housing in the direction of the receiving section in order to achieve a radially opposite orientation with the induction element of the tool holder with the relatively long clamping section. If, on the other hand, a tool holder with a relatively short clamping section were used, the induction element could be displaced in the opposite direction on the spindle housing in order to permit a radially opposite orientation of the induction element which is seated more highly in relation to the work spindle.

According to a further aspect of the invention, a machine tool is provided which comprises one of the spindle systems already described and which is configured for ultrasonic machining of a workpiece. Thanks to the spindle system comprised, such a machine tool can be used particularly efficiently and effectively in order to achieve ultrasonic machining. In particular, it can be used in highly automated environments since it can be combined seamlessly with automation devices such as tool changers and/or magazines. A particular advantage is that, despite the possibility of ultrasonic machining, no changes have to be made to the automation devices. This is made possible inter alia by the tool holders which are configured for ultrasonic machining by their tool receiving section and the induction element formed integrally with the clamping section. These can be clamped in the same way as conventional tool holders and can be gripped, displaced, positioned stored or retrieved and/or handled in another way by automation devices. This high degree of automation which can be achieved has a positive effect in particular on downtimes, with the result that the machine presented can be operated very economically.

In a particularly advantageous embodiment, a milling, grinding or drilling tool is received in the tool receiving section of the tool holder of the spindle system of the machine tool for ultrasonic machining. In this way, depending on the tool received, the machine can be used for the respective machining, that is to say for milling, grinding or drilling, wherein the respective tool can be vibrated by the vibration transducer in order to achieve ultrasonic machining of a workpiece surface. As a result, the flexibility of the machine tool is further increased.

According to a further advantageous embodiment, a tool with a geometrically determined or geometrically undetermined cutting edge is received in the tool receiving section of the tool holder of the spindle system of the machine tool for ultrasonic machining. This embodiment permits further adaptation of machining steps to a desired machining scenario.

### BRIEF DESCRIPTION OF THE FIGURES

FIG. 1 shows a cross section of a spindle system 100 with a received tool holder 400.

FIG. 2a shows a coil arrangement in the radial direction.

FIG. 2b shows a coil arrangement in the axial direction.

FIG. 3 shows a cross section of a tool receiving device of the tool holder 300 with a tool receiving section 404 and a coupled vibration transducer 405.

FIG. 4a shows an exploded view of a tool holder 400.

FIG. 4b shows the assembled tool holder 400 from FIG. 4a.

### DETAILED DESCRIPTION OF THE FIGURES

Examples or exemplary embodiments of the present invention are described in detail below with reference to the attached figures. Identical or similar elements in the figures can be denoted here by identical reference signs, but sometimes also by different reference signs.

It should be emphasized that the present invention is not, however, limited or restricted in any way to the exemplary embodiments described below and the embodiment features thereof, but rather furthermore comprises modifications of the exemplary embodiments, in particular those which are comprised by modifications of the features of the described examples or by combination of individual or a plurality of the features of the described examples within the scope of protection of the independent claims.

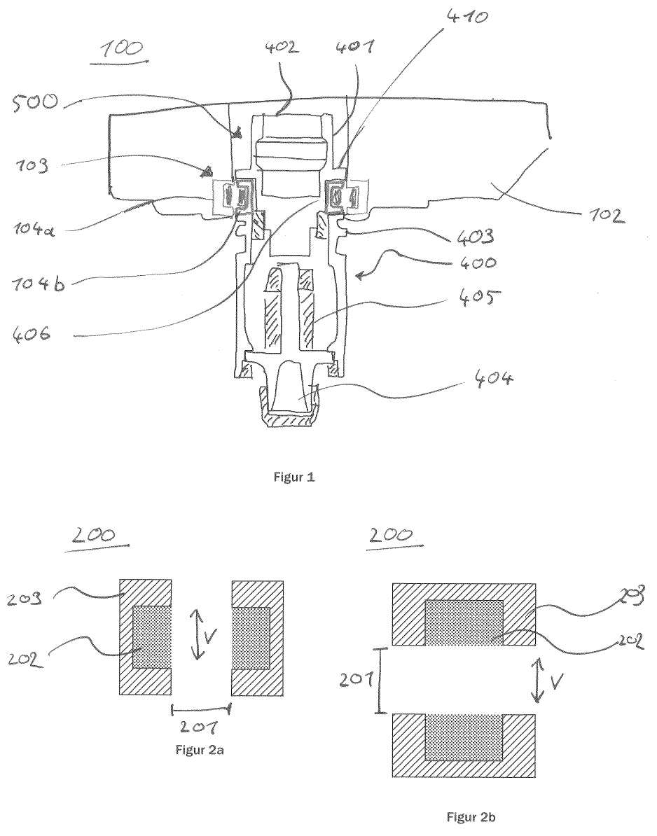

FIG. 1 shows a cross-sectional view of an advantageous embodiment of the spindle system 100 with a received tool holder 400. The energy transmission device 103 is embodied as a pair of annular coil-based induction elements 104 a, 104 b which are arranged radially opposite one another. Advantageously, the static coil 104 a is in this case arranged in the spindle housing 102. The arrangement of the coil 104 b co-rotating with the tool holder 400 in the clamping section 401 is advantageously selected in such a way that the advantageous radial orientation is produced when the tool holder 400 is connected to the work spindle (not shown). The advantages of this radial orientation are explained with reference to FIGS. 2a and 2b.

Furthermore, FIG. 1 shows that the induction element of the tool holder 104 b is countersunk in a groove 406 which runs around the tool holder. This is advantageous on account of a plurality of aspects.

Firstly, the induction element of the tool holder 104 b can in this way be adapted very well to the outer diameter of the tool holder 400. This permits the distance between the two induction elements (see 201 in FIG. 2a) to be kept small, which permits a high transmission efficiency of electrical energy between the induction elements.

Secondly, a diameter of the induction element 104 b which is embodied as a coil can be kept small in comparison with elements which are fastened to an outer side of the tool holder 400 without a groove. Centrifugal forces which act on the induction element 104 b during a rotation of the tool holder are thereby kept small. As a consequence, a tool holder 400 which has inserted or countersunk an induction element 104 b in a groove 406 can be turned at higher rotational speeds, as a result of which a surface quality of workpieces which are machined with a tool, which is used in such a tool holder 400, is improved.

It can be seen in particular in the sectional view in FIG. 1 that a gripper section 403 of the tool holder 400 is exposed and is not covered or concealed, for example, by the spindle housing 102. Furthermore, the gripper section of the tool holder 403 has arranged a plurality of engagement grooves in the embodiment shown in FIG. 1. The compatibility with a multiplicity of different automation devices can thereby be achieved. An automation device such as a gripper, a tool changer or the like can engage in the gripper section 403 from any desired direction from below the spindle housing 102. In particular, such an engagement is possible either from the axial direction from below the tool receiving section 404 or else from the radial direction.

The integral formation of induction element 104 b and clamping section of the tool holder 401 consequently permits particularly favourable arrangement of the first induction element 104 a, with the result that efficient energy transmission can take place without reducing the automation potential, for example with regard to the tool change.

FIG. 2a shows a cross section of a coil arrangement 200 of two coils 202, wherein both coils 202 are in each case enclosed in an element 203. This element 203 can be, for example, a groove 406 in the clamping region of a tool holder 400. In an alternative embodiment, the element 203 is a (partial) sheathing composed of a ferritic material. In such an embodiment, an induction element 104 a, 104 b would consequently comprise the (partial) sheathing composed of the ferritic material and the coil wound therein. The arrangements of the induction elements, as are explained in this description, are to be understood as being independent of the specific compositions of the corresponding induction elements.

In particular, FIG. 2a shows a radial coil arrangement, as was also realized in the embodiment of FIG. 1. For reasons of clarity, both coils are shown identically. It should be noted that the advantages of the radial coil arrangement also arise in the case of differently embodied coils.

The distance 201 between the coils is particularly relevant for the transmission efficiency of electrical energy from one coil to the other. The advantage of a radial arrangement can also be seen here, since the distance 201, as can also be seen from FIG. 1, does not depend on an axial position of the coils, but rather inter alia on the diameters of the annular coil elements 104 a, 104 b. If, therefore, for example on account of manufacturing tolerances of the tool holder 400, an axial misorientation, that is to say a displacement of the coils with respect to one another in the direction V, takes place, the distance 201 does not change in the case of radial orientation. As a consequence, the transmission efficiency is influenced only to a small extent.

It can be seen that such a misorientation in the case of the axial orientation of the coils 202 with respect to one another, as is known from the prior art and as is shown in FIG. 2 b, has a direct influence on the distance 201 of the coils with respect to one another. If a tool holder 400, that is to say for example too deeply, were fastened to the spindle, a distance between the coils 201 would be increased, which would have a direct negative influence on the transmission efficiency of electrical energy between the coils 202.

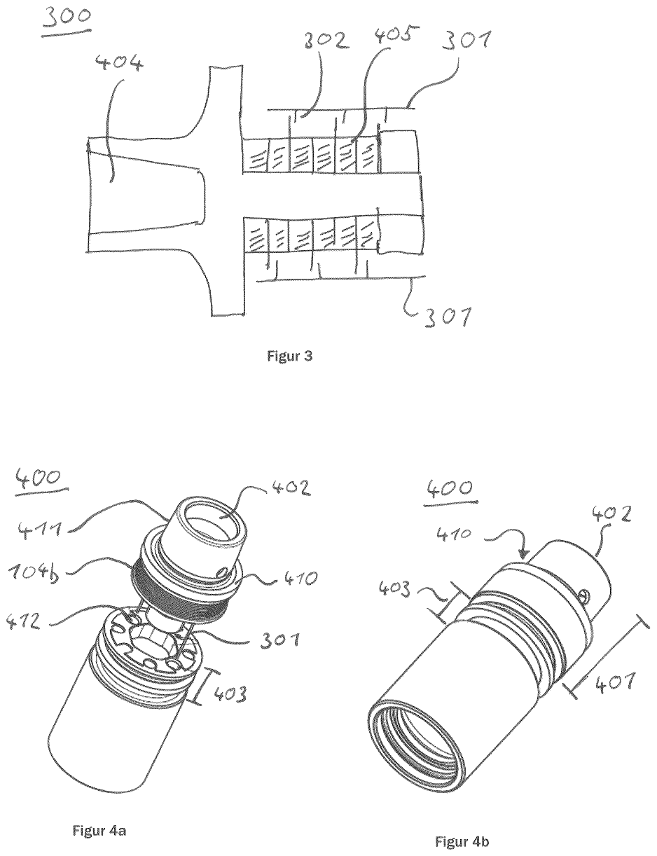

FIG. 3 shows a cross section of an advantageous embodiment of a tool receiving device 300 of the tool holder 400. In the embodiment shown, the vibration transducer 405 of the tool holder 400 is embodied as a stack of piezo elements. Particularly advantageously, lines 301 are provided on the tool receiving device 300, which lines are connected to the vibration transducer in a solder-free manner. In particular, a connection of the lines, which pass on electrical energy from the induction element 104b to the vibration transducer 405, to the vibration transducer 405 is established via a form fit 302. The advantages of such an embodiment have already been described above.

FIG. 4a shows an exploded drawing of an advantageous embodiment of the tool holder 400, wherein a connecting section of the tool holder, which connecting section comprises the clamping section 401 and the gripper section 403, is embodied in two parts. This embodiment permits particularly efficient production of the tool holder since the parts with the two sections 401, 403 can be produced independently of one another before they are assembled to form the connecting section of the tool holder 400. In order to facilitate assembly and integration of the induction element 104b, for example, bores 412 can be provided, through which the lines 301 can be passed, which lines connect the induction element 104b to the vibration transducer 405.

This embodiment is additionally advantageously embodied with a hollow shaft taper 411 as a clamping section 401. Particularly advantageous in this embodiment is the planar contact surface 410 which, in a state in which the tool holder 400 is connected to a work spindle, absorbs a large part of the clamping forces and thus improves the limiting load and rigidity of the taper-hollow shaft connection.

FIG. 4b shows the assembled tool holder 400 from FIG. 4a.

Examples or exemplary embodiments of the present invention and the advantages thereof have been described above in detail with reference to the attached figures.

It should be emphasized again that the present invention is not, however, limited or restricted in any way to the exemplary embodiments described above and the embodiment features thereof, but rather furthermore comprises modifications of the exemplary embodiments, in particular those which are comprised by modifications of the features of the described examples or by combination of individual or a plurality of the features of the described examples within the scope of protection of the independent claims.

### LIST OF REFERENCE SIGNS

100 Spindle system
102 spindle housing
103 energy transmission device
104a (static) induction element
104b (rotating) induction element
200 coil arrangement
201 coil spacing
202 coil
203 element surrounding coil
300 tool receiving device
301 line
302 connection by means of form fit
400 tool holder
401 clamping section
402 clamping end of the tool holder
403 gripper section
404 tool receiving section
405 vibration transducer
406 groove in the clamping section
410 planar contact surface
411 hollow shaft taper
412 bore for line leadthrough
500 spindle device

1. A spindle system (100) for use on a machine tool, comprising at least:
a spindle device (500) comprising a rotationally driven work spindle with a receiving section for releasably connecting a tool holder (400) and a spindle housing (102) in which the work spindle is mounted;
a tool holder (400) comprising at least:
a clamping section (401) for releasably connecting to a work spindle of a spindle device (100),
a gripper section (403) arranged below the clamping section (401) relative to a clamping end of the tool holder (402),
a tool receiving section (404), and
a vibration transducer (405) coupled to the tool receiving section (404) and configured to vibrate a machining tool received in the tool receiving section (404); and
an energy transmission device (103) comprising a first induction element (104a) and a second induction element (104b);
wherein the first induction element (104a) is arranged on the spindle housing (102) and the second induction element (104b) is arranged on the tool holder (400) in the clamping section (401) and, when the tool holder (400) is connected to the work spindle, the energy transmission device (103) is configured to transmit energy between the first induction element (104a) and the second induction element (104b) radially opposite the first induction element in a contactless manner for supplying energy to the vibration transducer (405); and
wherein the second induction element (104b) is formed integrally with the clamping section of the tool holder (401) such that an automated changing device can engage in the gripper section of the tool holder (403).

2. The spindle system (100) according to claim 1, wherein the clamping section of the tool holder (401) is formed as a hollow shaft taper (411).

3. The spindle (100) according to claim 1, wherein the clamping section of the tool holder (401) is formed as a steep taper.

4. The spindle (100) according to claim 1, wherein, for the purpose of transmitting electrical energy from the induction element of the tool holder (104b) to the vibration transducer (405), the tool holder (400) additionally comprises lines (301) which are connected to the vibration transducer (405) in a solder-free manner.

5. Tool A tool holder (400) for a spindle system (100) according to claim 1, at least comprising:
a clamping section (401) for releasably connecting to a work spindle of a spindle device (500),
a gripper section (403) arranged below the clamping section (401) relative to a clamping end of the tool holder (402),
a tool receiving section (404), and
a vibration transducer (405) coupled to the tool receiving section (404) and configured to vibrate a machining tool received in the tool receiving section (404),
wherein the tool holder (400) has arranged in the clamping section (401) an induction element (104b) which, when the tool holder (400) is connected to a work spindle, is configured to receive electrical energy in a contactless manner and to pass it on to the vibration transducer (405), and
wherein the induction element is formed integrally with the clamping section of the tool holder (401) such that an automated changing device can engage in the gripper section of the tool holder (403).

6. The tool holder (400) according to claim 5, wherein the clamping section (401) is formed as a hollow shaft taper (411).

7. The tool holder (400) according to claim 5, wherein the clamping section (401) is formed as a steep taper.

8. The tool holder (400) according to claim 5, wherein, for the purpose of transmitting electrical energy from the induction element (104b) to the vibration transducer (405), the tool holder (400) additionally comprises lines (301) which are connected to the vibration transducer (405) in a solder-free manner.

9. The tool holder (400) according to claim 5, wherein a connecting section of the tool holder, which connecting section comprises at least the clamping section (401) and the gripper section (403), is produced at least in two parts.

10. The tool holder (400) according to one of claims claim 5, wherein the induction element of the tool holder (104b) is at least partially embedded in a groove (406) which runs around the tool holder and is arranged in the clamping section of the tool holder (401).

11. The tool holder (400) according to claim 5, wherein an outer diameter of the clamping section of the tool holder (401) in a region in which the induction element (104b) is arranged is equal to or smaller than an outer diameter of the clamping section of the tool holder (401) in a region in which the induction element (104b) is not arranged.

12. The tool holder according to claim 5, wherein a relative change in an outer diameter of the clamping section (401) in the axial direction of the tool holder (400) in a region in which the induction element (104b) is arranged is equal to a relative change in the outer diameter of the clamping section (401) in the axial direction of the tool holder (400) in a region in which the induction element (104b) is not arranged.

13. A spindle device (500) for a spindle system (100) according to claim 1, comprising at least:
a rotationally driven work spindle with a receiving section for a tool holder (400) and
a spindle housing (102) in which the work spindle is mounted;
an induction element (104a) which is arranged on the spindle housing (102), wherein
the induction element (104a) is configured to transmit electrical energy to an induction element of the tool holder (104b) in a contactless manner when the tool holder (400) is connected to the work spindle.

14. A machine tool comprising a spindle system (100) according to claim 1, which is configured for ultrasonic machining of workpieces.

15. The machine tool according to claim 14, wherein a milling, grinding or drilling tool is received in the tool receiving section of the tool holder (404) of the spindle system (100) for ultrasonic machining.

16. The machine tool according to claim 14, wherein a tool with a geometrically determined or geometrically undetermined cutting edge is received in the tool receiving section of the tool holder (404) of the spindle system (100) for ultrasonic machining.
